(19) United States
(12) Patent Application Publication
(10) Pub. No.: US 2008/0021695 A1
(43) Pub. Date: Jan. 24, 2008

(54) ROM emulator and ROM testing method using the same

(76) Inventors: Jing-Rung Wang, Taipei (TW); Chia-Hsing Yu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/826,406

(22) Filed: Jul. 16, 2007

(30) Foreign Application Priority Data
Jul. 18, 2006 (TW) 095126249

(51) Int. Cl. G06F 9/455

(52) U.S. Cl. 703/24

(57) ABSTRACT

A ROM emulator is used for emulating an operation of a ROM to be inserted into a ROM socket of a motherboard. The ROM emulator includes a plurality of connectors, one of which is selected to be coupled to a connector of the motherboard for communicating the ROM emulator with the motherboard; a rewritable memory for storing therein BIOS codes in a rewritable manner; and a controller coupled to the plurality of connectors and the rewritable memory for controlling the transmission of the BIOS codes from the rewritable memory to the motherboard via the selected connector in a motherboard-identifiable format.

### FIELD OF THE INVENTION

The present invention relates to a ROM emulator, and more particularly to a ROM emulator for emulating operations of a ROM on a motherboard under diversified transmission interfaces. The present invention also relates to a ROM testing method, and more particular to a ROM testing method capable of testing a ROM on a motherboard under diversified transmission interfaces by using the same ROM emulator.

### BACKGROUND OF THE INVENTION

Due to the amazing power of personal computers, personal computers are applied to diversified fields. For example, personal computers simply used for word processing in earlier stages are now applicable to video/audio amusement purposes. For executing powerful functions, central processing units and peripheral devices of computer systems are increasingly developed for enhanced performance. Thus associated BIOSs (Basic Input Output Systems) need modifying to conform to the functions of the central processing units and peripheral devices. In order to assure of normal operation of a motherboard carrying a BIOS, verifying and modifying procedures of BIOS codes are repetitively alternately performed. Typically, the BIOS codes are stored in a ROM (Read-Only Memory), which is inserted in a ROM socket of the motherboard, and read by associated circuitry of the motherboard to be executed for initializing the computer system.

In the past, BIOS codes have to be physically recorded into a ROM and the ROM need be inserted into a motherboard before they can be tested. As a result, a number of ROMs and a lot of testing time and laboring are consumed for the repetitive verifying and modifying procedures of BIOS codes. For improving the procedures, a ROM emulator is used to emulate the ROM to be tested. The ROM emulator is made communicable with a motherboard via a ROM socket of a specified transmission interface on the motherboard and a transmission line. When the motherboard is initialized, it is preset to read BIOS codes from the ROM mounted in the ROM socket. Since there is no real ROM inserted into the ROM socket, the motherboard will then read BIOS codes from the ROM emulator via the transmission line. An external computer writes or modifies BIOS codes into the ROM emulator via a transmission line, and then the BIOS codes are read and executed by the motherboard to see how the motherboard works with the BIOS codes. In this manner, the BIOS codes can be easily tested and modified by the external computer without being physically recorded into the ROM.

Referring to FIG. 1, a schematic block diagram of a conventional ROM testing system is illustrated. The ROM testing system comprises a computer 13, a ROM emulator 10 in communication with the computer 13 via a transmission line 11, a ROM adapter 14 in communication with the ROM emulator 10 via a transmission line 12 and a motherboard 16 in communication with the ROM adapter 14 via a transmission line 15, wherein the transmission line 15 is coupled to a ROM socket 17 of the motherboard 16, where a ROM emulated by the ROM emulator 10 is to be inserted. The transmission interface of the conventional ROM emulator 10 and ROM adapter 14 are designed with an ISA (Industrial Standard Architecture) specification for conforming to the motherboard 16 of an ISA specification. Via the computer 13, the designer writes or modifies BIOS codes into a RAM (random access memory) 101 of the ISA ROM emulator 10. When the motherboard 16 is booted to be tested, it will read BIOS codes from the RAM 101 of the ISA ROM emulator 10 via the ROM adapter 14, and then executes the BIOS codes. According to the BIOS-code execution result of the motherboard 16, the designer can determine whether the motherboard 16 works well. If the execution result is unsatisfactory, the designer may further modify the BIOS codes via the compute 13 and store the updated BIOS codes into the RAM 101 for further access and execution by the motherboard 16.

In the conventional testing system mentioned above, the ROM emulator 10 is enabled to communicate with the motherboard 16 via the ROM adapter 14 and the two transmission lines 12 and 15. The complicated interconnection is not user-friendly. In addition, the ROM adapter 14 undesirably occupies extra space.

Nowadays, many kinds of new transmission interfaces in addition to ISA interface have been developed. For example, a low pin count (LPC) interface that has only 7 pins is advantageous over the ISA interface that has 40 pins in area and cost reduction of a ROM socket. As a result, there would be some vacated space for other functional circuitry so as to enhance performance of the motherboard. Furthermore, the transmission speed of LPC interface is not lowered even though the address and data signals are serially transmitted. Consequently, the LPC interface stands a good chance to replace the ISA interface.

Unfortunately, today's ROM emulator can only be used with a motherboard of an ISA specification, but is infeasible for motherboards of other specifications.

### SUMMARY OF THE INVENTION

Therefore, the present invention provides a ROM emulator and a ROM emulating method for emulating operations of a ROM on a motherboard under diversified transmission interfaces without a ROM adapter.

The present invention provides a ROM emulator for emulating an operation of a ROM (Read-Only Memory) to be inserted into a ROM socket of a motherboard. The ROM emulator includes a plurality of connectors, one of which is selected to be coupled to a connector of the motherboard for communicating the ROM emulator with the motherboard; a rewritable memory for storing therein BIOS (Basic Input Output System) codes in a rewritable manner; and a controller coupled to the plurality of connectors and the rewritable memory for controlling the transmission of the BIOS codes from the rewritable memory to the motherboard via the selected connector in a motherboard-identifiable format.

The present invention also relates to a ROM emulator for emulating an operation of a ROM (Read Only Memory) to be inserted into a ROM socket of a motherboard, which includes a connector device including a connector to be coupled to a general-purpose bus connector or a test connector of the motherboard for communicating the ROM emulator with the motherboard; a rewritable memory for storing therein BIOS (Basic Input Output System) codes in a rewritable manner; and a controller coupled to the connector device and the rewritable memory for controlling the transmission of the BIOS codes from the rewritable memory to the motherboard via the connector device and the general-purpose connector of the motherboard in a motherboard-identifiable format.

The present invention further relates to a ROM (Read-Only Memory) testing method for testing an operation of a ROM on a motherboard by using a ROM emulator to emulate the ROM. The method includes steps of: providing a plurality of connection paths selectable for communicating the ROM emulator with the motherboard according to a specification of the motherboard; reading BIOS codes from a rewritable memory of the ROM emulator to the motherboard through one of the plurality of paths in response to a control signal asserted by the motherboard; executing a testing procedure of the motherboard with the BIOS codes read from the rewritable memory; and determining whether the BIOS codes are verified according to a test result of the testing procedure.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic block diagram of a conventional ROM testing system;

FIGS. 2A˜2D are schematic block diagrams illustrating four embodiments of a ROM testing system using a ROM emulator according to the present invention; and

FIG. 3 is a flowchart illustrating a ROM testing method according to an embodiment of the present invention.

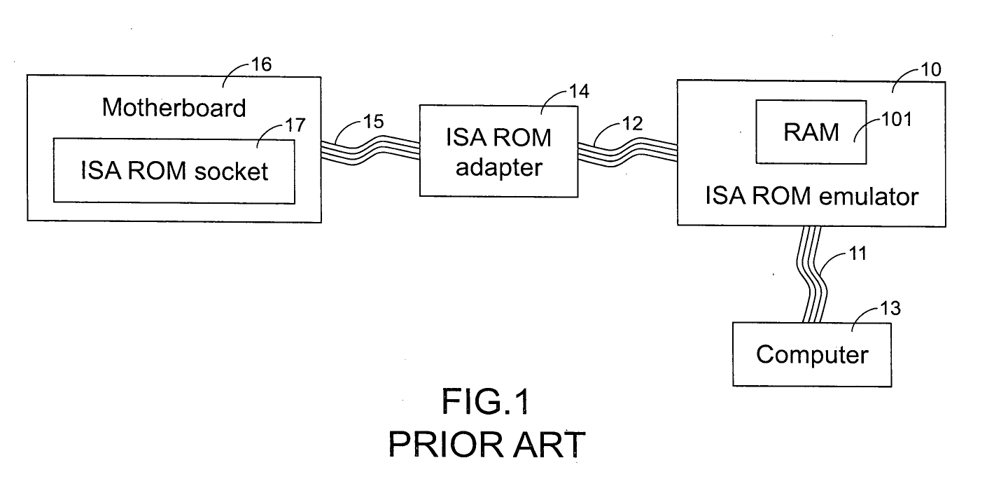

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

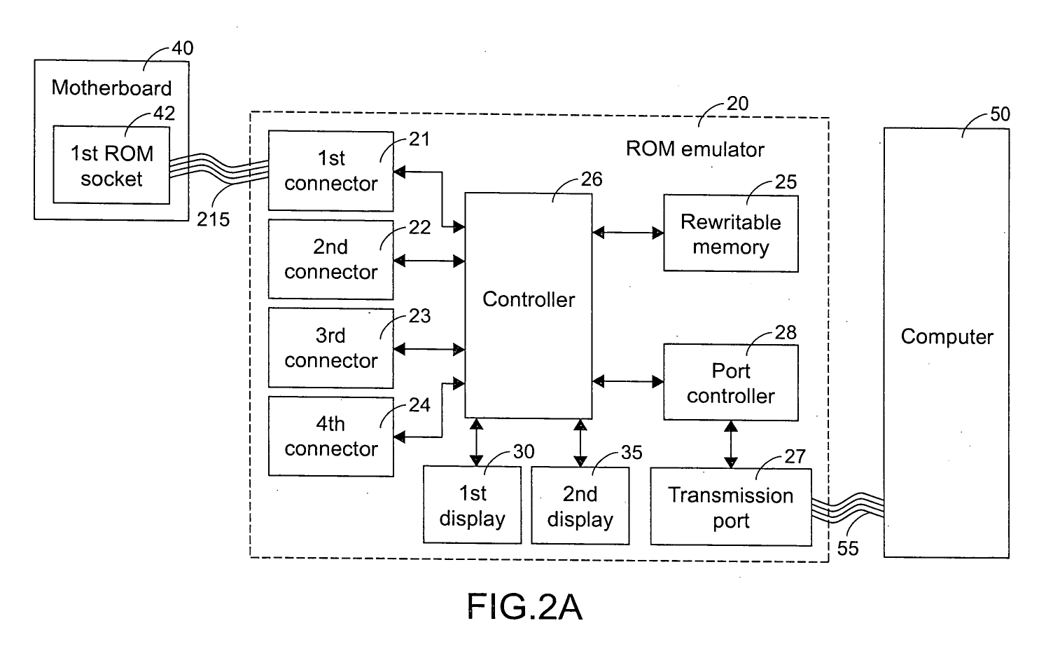

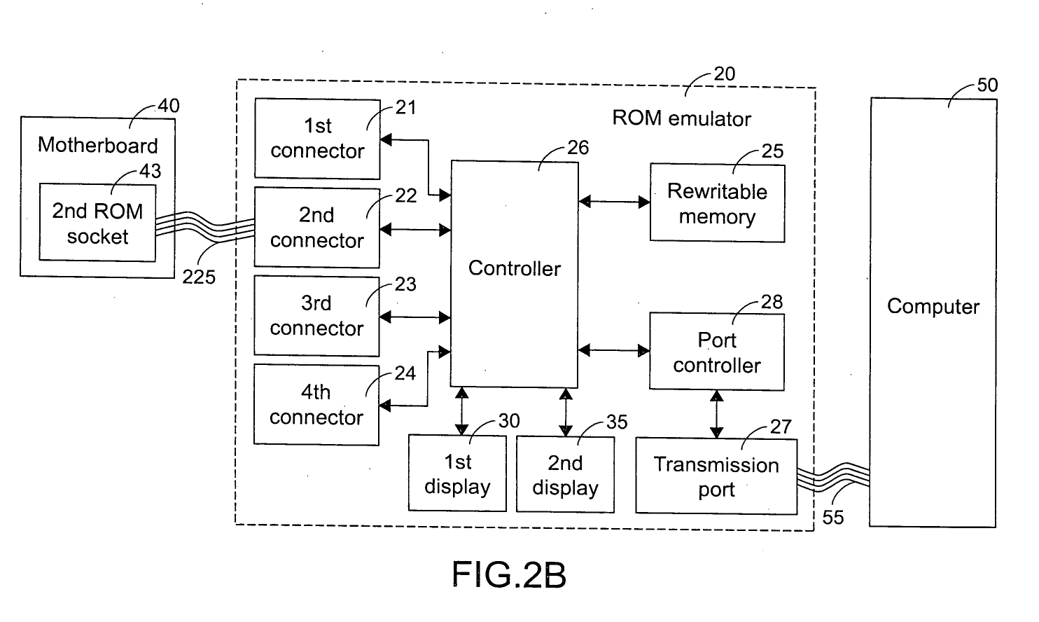

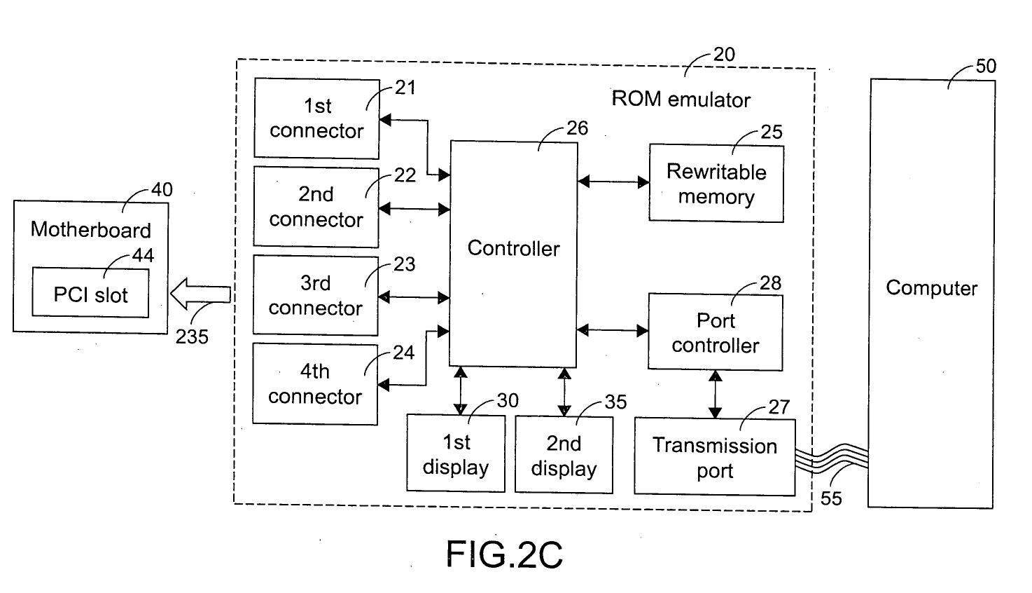

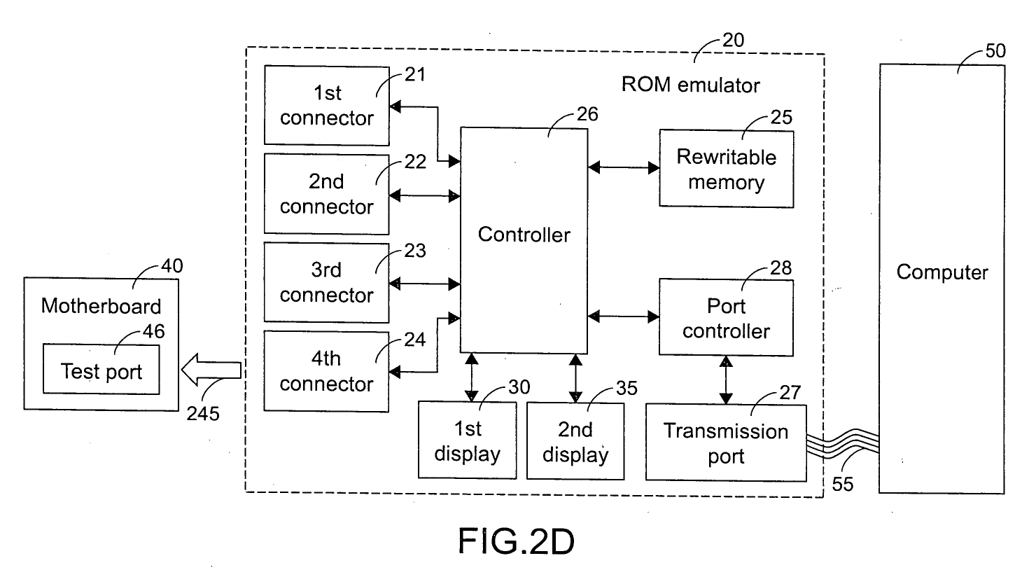

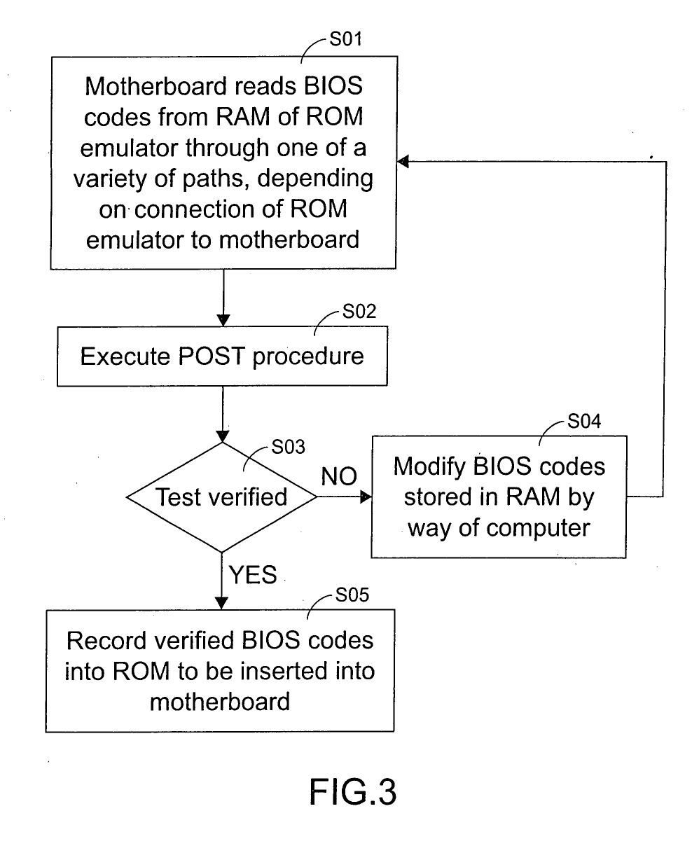

Referring to any of FIGS. 2A˜2D, a ROM testing system using a multi-interfaced ROM emulator according to an embodiment of the present invention is illustrated. The ROM emulating system comprises a ROM emulator 20, a computer 50 in communication with the ROM emulator 20 via a transmission line 55 and a motherboard 40 where a ROM emulated by the ROM emulator 20 is to be inserted in communication with the ROM emulator 20 via an optional path. For testing the ROM, the motherboard 40 is supposed to read BIOS codes from a ROM mounted therein. Since there is no real ROM inserted into the ROM socket of the motherboard 40, the motherboard 40 reads BIOS codes from a rewritable memory 25 in the ROM emulator 20 through one of a variety of paths 215 (FIG. 2A), 225 (FIG. 2B), 235 (FIG. 2C) and 245 (FIG. 2D) (Step S01), and executes a POST (power on self test) procedure to see how the emulated ROM works with the circuitry of the motherboard 40 (Step S02). If the testing result shows a need to modify the ROM (Step S03), the BIOS codes stored in the rewritable memory 25 in the ROM emulator 20 can be arbitrarily modified by way of the computer 50 (Step S04). The modifying and testing procedures can be repeated as many times as needed until the emulating result is satisfactory (Step S05), as illustrated in the flowchart of FIG. 3.

For implementing the above-described testing method, the ROM emulator 20 is designed with a variety of connectors to communicate with the motherboard 40. For example, the ROM emulator 20 includes an ISA connector 21, an LPC connector 22, a general-purpose bus connector such as PCI connector 23 and a test port connector 24. If the ROM socket of the motherboard 40 is of an ISA specification, as shown in FIG. 2A, the ROM emulator 20 can be made communicable with the motherboard 40 by coupling the ISA connector 21 to the ISA ROM socket 42 via an ISA transmission line 215. On the other hand, if the ROM socket of the motherboard 40 is of an LPC specification, as shown in FIG. 2B, the ROM emulator 20 can be made communicable with the motherboard 40 by coupling the LCP connector 22 to the LPC ROM socket 43 via an LPC transmission line 225.

If the motherboard 40 supports a PCI (Peripheral Component Interconnect) specification, the ROM emulator 20 can alternatively be inserted into a PCI slot 44 of the motherboard 40 via the PCI connector 23, as shown in FIG. 2C, no matter whether the ROM socket of the motherboard 40 is of an ISA or LPC specification. In a further embodiment as shown in FIG. 2D, the ROM emulator 20 can alternatively be inserted into a test port 46 of the motherboard 40 via the test port connector 24 no matter whether the ROM socket of the motherboard 40 is of an ISA or LPC specification. For example, the test port 46 can be an LPC male port while the test port connector 24 is an LPC female port. In these two embodiments, direct connection 235 or 245 can be made between the ROM emulator 20 and the motherboard 40, exempting from the use of any transmission line.

It is understood by those skilled in the art that the above sockets 42, 43, PCI slot 44 and test port 46 are optionally disposed in the motherboard 40. Of course, they can be co-existent in the motherboard 40, and one of the connecting means is selected and coupled to the ROM emulator 20 for testing.

In addition to the connectors 21, 22, 23 and 24, the ROM emulator 20 further includes the rewritable memory 25 to which the computer 50 may access so as to modify the BIOS codes, and a controller 26 coupled to the connectors 21, 22, 23 and 24 and rewritable memory 25 for controlling the data transmission between the connectors 21, 22, 23 and 24 and rewritable memory 25 so as to allow the motherboard 40 to successfully read and execute BIOS codes stored in the rewritable memory 25 via one of the connectors 21, 22, 23 and 24. The rewritable memory 25, for example, can be an ASRAM (Asynchronous Static Random Access Memory) or a flash memory. The controller 26 is an ASIC (Application Specific Integrated Circuit) controller or a CPLD (Complex Programmable Logic Device) controller.

Moreover, the ROM emulator 20 further includes a transmission port 27 and a transmission port controller 28 to communicate with the computer 50 through the transmission line 55. The transmission port 27 and transmission line 55, for example, can be a USB (Universal Serial Bus) port and a USB transmission line to enable high-speed BIOS-code loading from the computer 50 to the rewritable memory 25. The transmission port controller 28, for example, can be a USB+8051 controller coupled between the transmission port 27 and the controller 26. The BIOS codes are transmitted from the transmission port 27 to the controller 26, and then written into the rewritable memory 25 under the control of the controller 26. When the controller 26 loads the BIOS codes to the rewritable memory 25, the BIOS codes will be optionally converted into a proper format, e.g. ISA or LPC, by the controller 26 to be stored in the rewritable memory 25, depending on the data storage format of the rewritable memory 25.

For example, referring to FIG. 2A, the ROM socket 42 is of an ISA specification and the rewritable memory 25 transmits data in an ISA format. Since the signal definitions of these two devices are both parallel and their access clock signals are compatible, the controller 26 does not have to convert the format of the BIOS codes but directly transfers the BIOS codes from the rewritable memory 25 to the motherboard 40 via the connector 21, the transmission line 215 and ROM socket 42. Meanwhile, the controller 26 will adjust the signal level received from the motherboard 40, e.g. from +5V to +3.3V) to comply with the level requirement of the rewritable memory 25, and vice versa, adjust the signal level read from the rewritable memory 25, e.g. from +3.3V to +5V, to comply with the level requirement of the motherboard 40. Furthermore, the controller 26 buffers the control signal transmitted from the motherboard 40 and the BIOS codes transmitted from the computer 50 so as to avoid collision.

In anther example as illustrated in FIG. 2B, the ROM socket 43 is of an LPC specification, which is a serial format, while the rewritable memory 25 transmits data in a parallel ISA format. Under this circumstance, the controller 26 needs to conduct a conversion between the LPC and ISA interfaces so as to achieve coincidence in signal definition and access clock. First of all, the control signal asserted by the motherboard 40 is converted from a serial format into a parallel format and the access clock signal is adjusted from 33 MHz into 8 MHz by the controller 26 in order to comply with the requirement of the rewritable memory 25 for reading the BIOS codes. Then the controller 26 converts the BIOS codes read from the rewritable memory 25 from the parallel format into serial format. Meanwhile, the controller 26 also adjusts the access clock signal from 8 MHz into 33 MHz to allow the BIOS codes to be successfully transmitted via the connector 22, transmission line 225 and ROM socket 43 to be executed by the motherboard 40.

In a further example as illustrated in FIG. 2C, the ROM emulator 20 is directly inserted into the PCI slot 44 with the PCI-pin connector 23 to save space and simplify the connecting operation. In this case, the controller 26 needs to make proper conversion between the PCI and ISA specification. Although PCI and ISA specifications are both in a parallel format, some factors including the access clock are still required adjustment. Therefore, the controller 26 first conducts PCI/ISA conversion of the control signal asserted by the motherboard 40 with the adjustment of the access clock from 33 MHz to 8 MHz or from 66 MHz to 8 MHz. Subsequently, the controller 26 reads BIOS codes from the rewritable memory 25 while transforming the transmission format from ISA to PCI and adjusting the access clock from 8 MHz to 33 MHz or 66 MHz, thereby allowing the BIOS codes to be successfully transmitted from the rewritable memory 25 to the motherboard 40 via the connector 23 and PCI slot 43.

Likewise, in a yet another example as illustrated in FIG. 2D, the ROM emulator 20 is directly coupled into the additional test port 46, which is of a LPC specification, so the controller 26 needs to convert the control signal asserted by the motherboard 40 into the format identifiable by the rewritable memory 25, and then converts the BIOS codes read from the rewritable memory 25 into the format identifiable by the motherboard 40. Accordingly, the BIOS codes can be successfully transmitted from the rewritable memory 25 to the motherboard 40 to be executed via the connector 24 and test port 46.

In the above embodiments, the motherboard 40, after realizing identifiable BIOS codes from the rewritable memory 25, executes a POST (power on self test) procedure to see whether the emulated ROM well works with the circuitry of the motherboard 40. During the test procedure, post/debug codes are optionally generated and transmitted to I/O ports of the motherboard 40, e.g. the I/O ports at addresses 80 h and 84 h. Meanwhile, the ROM emulator 20 picks up and decodes the post/debug codes, and informs the designer of the decoded data, for example, by the displays 30 and/or 35. The displays 30 and 35 can be seven-segment displays. By way of the displays 30 and 35, the designer is able to realize the post/debug codes and decoded data directly without the use of an additional debug card, which is generally inserted into a PCI slot, to show the test result. In general, the transmission of debug codes, like the control signal and BIOS codes, may need conversion depending on the transmission specifications of the motherboard 40 and ROM emulator 20.

From the above description, it is understood a ROM emulator of the present invention is multi-interfaced and provides a variety of connection paths to communicate with a motherboard for testing a ROM emulated by the present ROM emulator to be inserted into the motherboard. Therefore, the applications of the present ROM emulator are diversified. Furthermore, since the ROM adapter used in the prior art is omitted, the space utility of the ROM testing system is enhanced. Moreover, in addition to the connection to a ROM socket via a transmission line, the ROM emulator can also be directly inserted into the motherboard through an interface such as a PCI slot or test port so as to save space, cost and laboring. Aside from, the provision of one or more displays in the present ROM emulator for showing test results will facilitate the designer's work.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A ROM emulator for emulating an operation of a ROM (Read-Only Memory) to be inserted into a ROM socket of a motherboard, comprising:
a plurality of connectors, one of which is selected to be coupled to a connector of the motherboard for communicating the ROM emulator with the motherboard;
a rewritable memory for storing therein BIOS (Basic Input Output System) codes in a rewritable manner; and
a controller coupled to the plurality of connectors and the rewritable memory for controlling the transmission of the BIOS codes from the rewritable memory to the motherboard via the selected connector in a motherboard-identifiable format.

2. The ROM emulator according to claim 1 wherein the plurality of connectors include an ISA (Industrial Standard Architecture) connector of an ISA specification, which is selectable to be coupled to the ROM socket for communicating the ROM emulator with the motherboard therevia when the ROM socket of the motherboard is of the ISA specification, and an LPC (Low Pin Count) connector of an LPC specification, which is selectable to be coupled to the ROM socket for communicating the ROM emulator with the motherboard therevia when the ROM socket of the motherboard is of the LPC specification.

3. The ROM emulator according to claim 1 wherein the plurality of connectors includes a PCI (Peripheral Component Interconnect) connector of a PCI specification, which is selectable to be coupled to a PCI slot of the motherboard for communicating the ROM emulator with the motherboard therevia.

4. The ROM emulator according to claim 1 wherein the plurality of connectors include a test-port connector, which is selectable to be coupled to a test port of the motherboard for communicating the ROM emulator with the motherboard therevia.

5. The ROM emulator according to claim 1 wherein the rewritable memory is a RAM (Random Access Memory) of an ISA specification.

6. The ROM emulator according to claim 1 wherein the controller is an ASIC (Application Specific Integrated Circuit) controller or a CPLD (Complex Programmable Logic Device) controller.

7. The ROM emulator according to claim 1 further comprising a display device for showing an execution result of the BIOS codes read from the rewritable memory and executed by the motherboard.

8. The ROM emulator according to claim 1 further comprising a transmission port to be coupled to an external computer, and a port controller for controlling the receiving of modified BIOS codes from the external computer via the transmission port to be stored in the rewritable memory.

9. The ROM emulator according to claim 8 wherein the transmission port is a USB (Universal Serial Bus) port, and the port controller is a USB controller.

10. A ROM emulator for emulating an operation of a ROM (Read Only Memory) to be inserted into a ROM socket of a motherboard, comprising:
a connector device including a connector to be coupled to a general-purpose bus connector or a test connector of the motherboard for communicating the ROM emulator with the motherboard;
a rewritable memory for storing therein BIOS (Basic Input Output System) codes in a rewritable manner; and
a controller coupled to the connector device and the rewritable memory for controlling the transmission of the BIOS codes from the rewritable memory to the motherboard via the connector device and the general-purpose connector of the motherboard in a motherboard-identifiable format.

11. The ROM emulator according to claim 10 wherein the connector device further include an ISA (Industrial Standard Architecture) connector of an ISA specification, which is selectable to be coupled to the ROM socket for communicating the ROM emulator with the motherboard therevia when the ROM socket of the motherboard is of the ISA specification, and an LPC (Low Pin Count) connector of an LPC specification, which is selectable to be coupled to the ROM socket for communicating the ROM emulator with the motherboard therevia when the ROM socket of the motherboard is of the LPC specification.

12. The ROM emulator according to claim 10 wherein the general-purpose connector of the motherboard and the connector to be coupled to the general-purpose bus connector are a PCI (Peripheral Component Interconnect) slot and a PCI pin, respectively.

13. The ROM emulator according to claim 10 wherein the test connector of the motherboard and the connector to be coupled to the test connector are a male connector and a female connector of a LPC specification, respectively.

14. A ROM (Read-Only Memory) testing method for testing an operation of a ROM on a motherboard by using a ROM emulator to emulate the ROM, the method comprising steps of:
providing a plurality of connection paths selectable for communicating the ROM emulator with the motherboard according to a specification of the motherboard;
reading BIOS codes from a rewritable memory of the ROM emulator to the motherboard through one of the plurality of paths in response to a control signal asserted by the motherboard;
executing a testing procedure of the motherboard with the BIOS codes read from the rewritable memory; and
determining whether the BIOS codes are verified according to a test result of the testing procedure.

15. The ROM emulator according to claim 14 further comprising a step of picking up and decoding debug codes generated during the testing procedure, and revealing the debug codes on a display of the ROM emulator.

16. The ROM emulator according to claim 14 further comprising a step of converting a format of the control signal asserted by the motherboard into a format identifiable by the rewritable memory of the ROM emulator, and then converting a format of the BIOS codes read from the rewritable memory into a format identifiable by the motherboard.

17. The ROM emulator according to claim 14 further comprising a step of converting an access clock of the control signal asserted by the motherboard into a format identifiable by the rewritable memory of the ROM emulator, and then converting an access clock of the BIOS codes read from the rewritable memory into a format identifiable by the motherboard.

18. The ROM emulator according to claim 14 further comprising a step of converting a signal definition of the control signal asserted by the motherboard into a format identifiable by the rewritable memory of the ROM emulator, and then converting a signal definition of the BIOS codes read from the rewritable memory into a format identifiable by the motherboard.

19. The ROM emulator according to claim 14 further comprising a step of modifying the BIOS codes by way of an external computer when the BIOS codes fail to pass the verification.

20. The ROM emulator according to claim 14 wherein the plurality of connection paths are provided by disposing a plurality of connectors of different specifications in the ROM emulator and using a controller to coordinate data transmission between the ROM simulator and the motherboard via one of the plurality of connectors.
